(19) United States
(12) Patent Application Publication
(10) Pub. No.: US 2015/0058774 A1
(43) Pub. Date: Feb. 26, 2015

(54) GESTURE-BASED VISUALIZATION OF FINANCIAL DATA

(71) Applicant: INTUIT INC., Mountain View, CA (US)

(72) Inventors: Mithun U. Shenoy, Bangalore (IN); Samir Revti Kakkar, Bangalore (IN); Anu Sreepathy, Bangalore (IN); Sunil H. Madhani, Sammamish, WA (US)

(73) Assignee: INTUIT INC., Mountain View, CA (US)

(21) Appl. No.: 13/973,326

(22) Filed: Aug. 22, 2013

(51) Int. Cl. G06F 3/0488

(52) U.S. Cl. CPC G06F 3/0488
USPC 715/771

(57) ABSTRACT

The disclosed embodiments provide a system that processes financial data. During operation, the system provides a user interface for displaying the financial data to a user. Upon detecting a gesture provided by the user through the user interface, the system identifies a context associated with the gesture. Next, the system displays a visualization of the financial data within the user interface based on the context.

### BACKGROUND

### Related Art

The disclosed embodiments relate to techniques for processing data. More specifically, the disclosed embodiments relate to techniques for providing gesture-based visualizations of financial data.

Application software may be used to perform tasks of varying duration and complexity. Furthermore, different amounts of user input and/or interaction with the software may be required to complete the tasks. For example, a user may spend several hours entering information into a tax preparation application to prepare and file his/her taxes, several minutes on an email client to send and receive emails, and/or several seconds starting and setting up a media player to play music. User experiences with an application may also vary based on the application's complexity, the user's familiarity with the application, and/or the domain of the application. For example, an accountant may find a tax preparation application to be simple or straightforward to use, while a user unfamiliar with tax law may find the same tax preparation application to be unusable.

Intelligent user interface design may facilitate interaction between an application and users of varying ability levels. For example, complex applications may include tutorials that explain the use of various features in the applications to the user. User interfaces may also leverage techniques for providing and/or displaying data to facilitate access to and/or understanding of the applications by the users. For example, understanding and/or use of a feature in an application may be facilitated by showing data associated with the feature in a pop-up, and/or overlay within the application's user interface.

Similarly, the arrangement of user interface elements may affect the user's ability to navigate the user interface. Consequently, user satisfaction with an application may be highly influenced by characteristics of the application's user interface.

### SUMMARY

The disclosed embodiments provide a system that processes financial data. During operation, the system provides a user interface for displaying the financial data to a user. Upon detecting a gesture provided by the user through the user interface, the system identifies a context associated with the gesture. Next, the system displays a visualization of the financial data within the user interface based on the context.

In some embodiments, upon detecting a complementary gesture provided by the user through the user interface, the system also removes the visualization from the user interface.

In some embodiments, the gesture includes a first motion, and the complementary gesture includes a second motion that is opposite the first motion.

In some embodiments, identifying the context associated with the gesture involves at least one of:

(i) identifying a type of the gesture;

(ii) obtaining a region of the user interface associated with the gesture;

(iii) identifying one or more keywords associated with the region; and

(iv) matching the one or more keywords to the financial data.

In some embodiments, if the financial data matches more than one keyword, matching the one or more keywords to the financial data involves obtaining, from the user, a selection of a keyword from the one or more keywords, and obtaining a subset of the financial data matching the keyword.

In some embodiments, the visualization includes at least one of a chart, a list, a map, a hierarchy, a network, and a table.

In some embodiments, the gesture is at least one of a pinching gesture, a tapping gesture, a press-and-hold gesture, a panning gesture, and a swiping gesture.

In some embodiments, the visualization is displayed within an overlay in the user interface.

### BRIEF DESCRIPTION OF THE FIGURES

FIG. 1 shows a schematic of a system in accordance with the disclosed embodiments.

FIG. 2 shows the identifying of a context associated with a gesture in accordance with the disclosed embodiments.

FIG. 3A shows an exemplary screenshot in accordance with the disclosed embodiments.

FIG. 3B shows an exemplary screenshot in accordance with the disclosed embodiments.

FIG. 4 shows a flowchart illustrating the processing of data in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

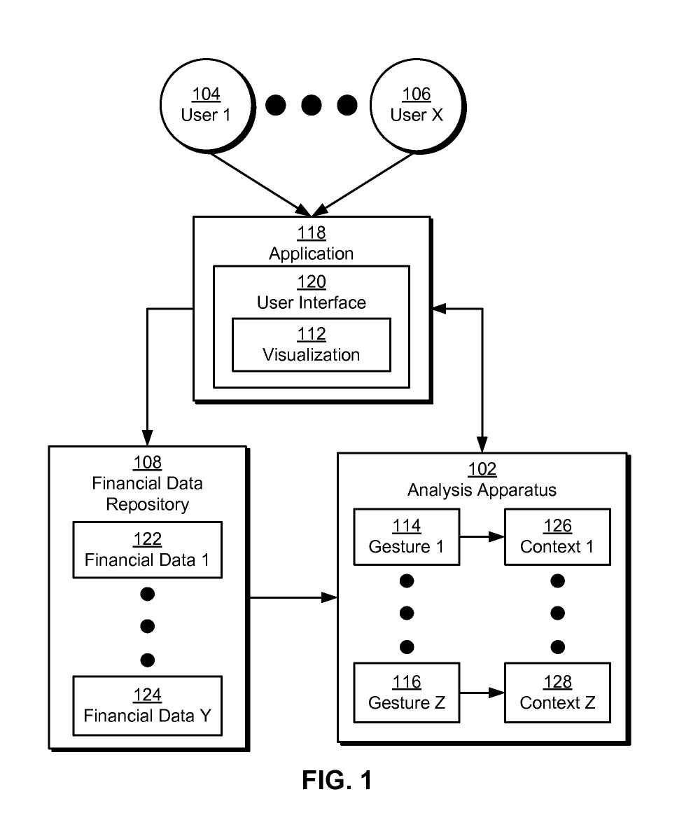

The disclosed embodiments provide a method and system for facilitating use of an application. As shown in FIG. 1, an application 118 may be used by a set of users (e.g., user 1 104, user x 106). Application 118 may correspond to a software program that is executed by a computing device, such as a personal computer (PC), laptop computer, mobile phone, portable media player, and/or server computer.

In addition, application 118 may be configured to display, process, and/or perform tasks related to financial data (e.g., financial data 1 122, financial data y 124) for the users. For example, application 118 may be a financial-management application, accounting application, tax-preparation application, banking application, and/or bill-payment application. As a result, application 118 may be used with bills, invoices, receipts, tax forms, statements, financial accounts, and/or other financial documents and/or sources of financial data. After the financial data is imported into application 118 and/or created within application 118, the financial data may be stored in a financial data repository 108 for subsequent processing and/or use with application 118.

Application 118 may be distributed across one or more machines and accessed in various ways. For example, application 118 may be installed on a personal computer (PC) and executed through an operating system on the PC. Alternatively, application 118 may be implemented using a client-server architecture. Application 118 may be executed on one or more servers and accessed from other machines using a locally installed executable and/or a web browser and network connection. In other words, application 118 may be implemented using a cloud computing system that is accessed over the Internet. Regardless of the method of access, use of application 118 by the users may be facilitated by a user interface 120.

In particular, interaction between the users and application 118 may be enabled by user interface 120. For example, the users may provide interactive input (e.g., page clicks, text input, file uploads, gestures, etc.) to application 118 through a graphical user interface (GUI) provided by application 118 and view text, images, documents, menus, icons, form fields, web pages, and/or other elements of application 118 through the same GUI. Those skilled in the art will appreciate that other types of user interfaces, such as command line interfaces and/or web-based user interfaces, may also be used by application 118. Thus, application 118 is able to perform tasks by receiving input from and providing output to the users through user interface 120.

Those skilled in the art will appreciate that a user's overall experience with application 118 may be affected by factors such as the user's familiarity with application 118, the user's knowledge of the domain of application 118, and/or the design or layout of application 118. For example, a user may access an invoice through application 118 after searching for the invoice and/or selecting a link to the invoice within user interface 120. In other words, the user may be required to perform a series of manual steps and/or navigate user interface 120 to obtain the desired financial data. As a result, the user may find accessing financial data within application 118 to be time-consuming, tedious, and/or confusing.

In one or more embodiments, the system of FIG. 1 facilitates use of application 118 by providing gesture-based visualizations of financial data within user interface 120. In particular, a user may access additional financial data related to data displayed within user interface 120 by providing a gesture (e.g., gesture 1 114, gesture z 116) through user interface 120. The gesture may include a pinching gesture, a tapping gesture, a press-and-hold gesture, a panning gesture, and/or a swiping gesture. For example, the gesture may be performed using a touchscreen, touchpad, motion-sensing device, and/or other input/output (I/O) mechanism with the capability to sense multi-touch gestures.

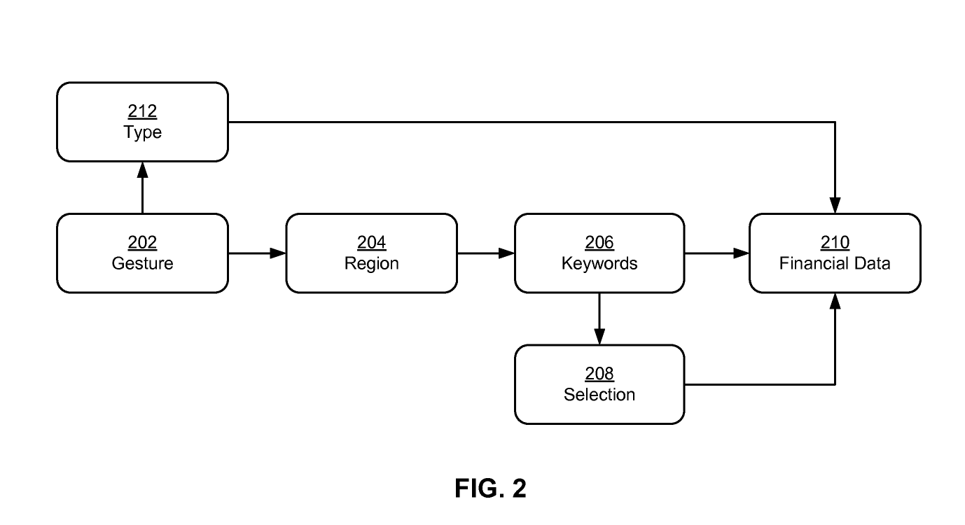

After the gesture is detected by user interface 120, application 118, and/or another component associated with interaction with the user, an analysis apparatus 102 may identify a context (e.g., context 1 126, context z 128) associated with the gesture. As discussed in further detail below with respect to FIG. 2, analysis apparatus 102 may determine the context based on a type of the gesture, a region of user interface 120 associated with the gesture, one or more keywords associated with the region, and/or a match between the keyword(s) and financial data in financial data repository 108.

User interface 120 may then display a visualization 112 of the financial data based on the context. For example, user interface 120 may display visualization 112 as a chart, a list, a map, a hierarchy, a network, and/or a table containing financial data associated with the context. In addition, visualization 112 may be displayed within an overlay in user interface 120 to allow the user to access the financial data without navigating away from the screen at which the gesture was received.

Consequently, the user may obtain additional information associated with financial data displayed within user interface 120 by providing a single gesture in the region of the displayed financial data. For example, the user may view a list and/or table containing details of transactions with a customer by performing a pinching gesture over a name of the customer. Thus, the user may access the details of the transactions and/or perform tasks related to the transactions more quickly and/or efficiently than if the user were required to navigate away from the screen containing the customer's name to a screen containing records of transactions for the customers.

The user may then remove visualization 112 from user interface 120 by performing a complementary gesture to the initial gesture used to trigger the display of visualization 112. The complementary gesture may include a motion that is opposite the motion of the initial gesture. For example, the user may perform a pinching gesture with a “zooming out” motion to view visualization 112 within an overlay in user interface 120 and a pinching gesture with a “zooming in” motion to remove the overlay and/or visualization 112.

As with the initial gesture, analysis apparatus 102 may identify a context for the complementary gesture based on the region of user interface 120 within which the complementary gesture was received, a type of the complementary gesture, and/or the presence of visualization 112 in user interface 120. Once the context and/or purpose of the complementary gesture are identified, application 118 may remove visualization 112 from user interface 120.

Those skilled in the art will appreciate that the system of FIG. 1 may be implemented in a variety of ways. More specifically, application 118, financial data repository 108, and analysis apparatus 102 may execute on the same system or on different systems. For example, analysis apparatus 102 may execute within application 118 or independently of application 118. Along the same lines, application 118, financial data repository 108, and analysis apparatus 102 may be provided by a single physical machine, multiple computer systems, one or more virtual machines, a grid, one or more databases, one or more file systems, and/or a cloud computing system.

FIG. 2 shows the identifying of a context associated with a gesture 202 in accordance with the disclosed embodiments. The context may be associated with financial data 210 that is subsequently displayed within a visualization (e.g., visualization 112 of FIG. 1) to a user in response to gesture 202.

Gesture 202 may be performed within a region 204 of a user interface, such as user interface 120 of FIG. 1. For example, gesture 202 may be performed over a specific region 204 of a touchscreen containing the user interface and/or while a cursor is placed over region 204 in the user interface. One or more keywords 206 associated with region 204 may then be identified. For example, keywords 206 may be displayed within and/or near region 204 in the user interface.

Keywords 206 may then be matched to financial data 210 that is subsequently displayed in the visualization. For example, a database lookup using keywords 206 may be performed to obtain financial data 210 for the user that is associated with and/or contains keywords 206. If financial data 210 matches more than one keyword, a selection 208 of a keyword from the matched keywords may be obtained from the user, and financial data 210 matching selection 208 may be used in the context. For example, a list of keywords 206 matching financial data 210 may be shown to the user within the user interface, and the user may provide selection 208 by tapping a keyword in the list.

As mentioned above, gesture 202 may include a pinching gesture, a tapping gesture, a press-and-hold gesture, a panning gesture, and/or a swiping gesture. As a result, the context may further be based on a type 212 of gesture 202 performed by a user. For example, a press-and-hold gesture may be associated with one type of financial data 210, while a panning gesture may be associated with a different type of financial data 210.

Those skilled in the art will appreciate that other attributes may be used to identify the context of gesture 202. For example, the type of financial data 210 and/or the visualization shown in response to gesture 202 may also be influenced by the presence of buttons, menus, icons, links, and/or other user-interface elements in or near region 204. Similarly, the user may configure the display of a certain type of financial data 210 and/or visualization in response to a certain type 212 of gesture 202 and/or keywords 206 or user-interface elements associated with region 204 in which gesture 202 was received.

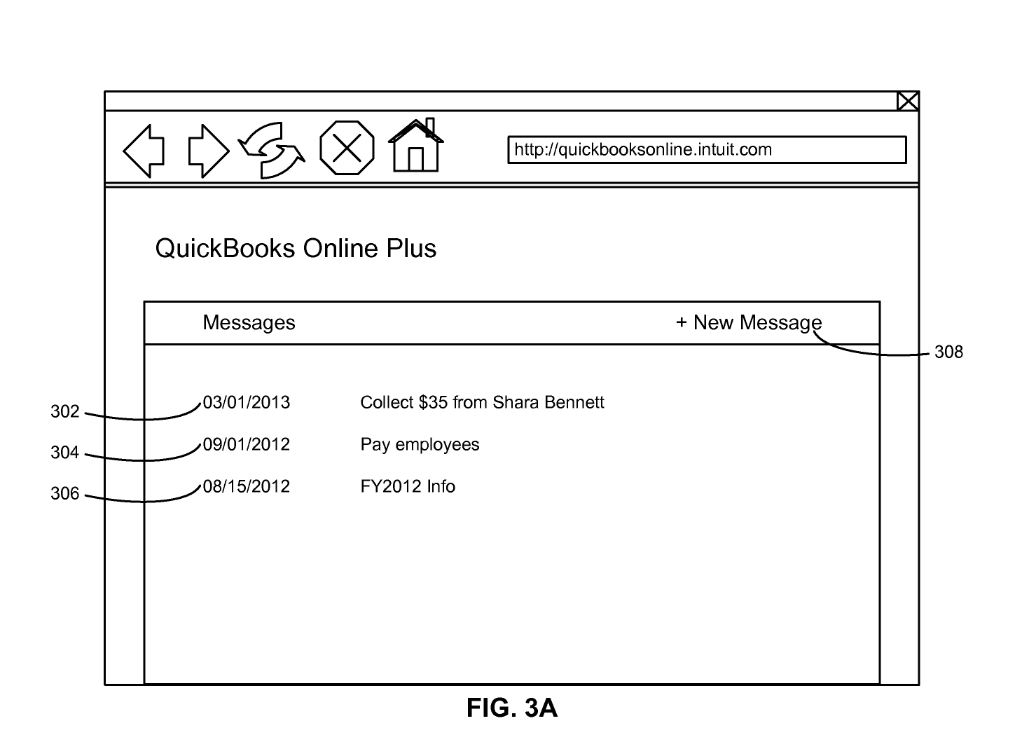

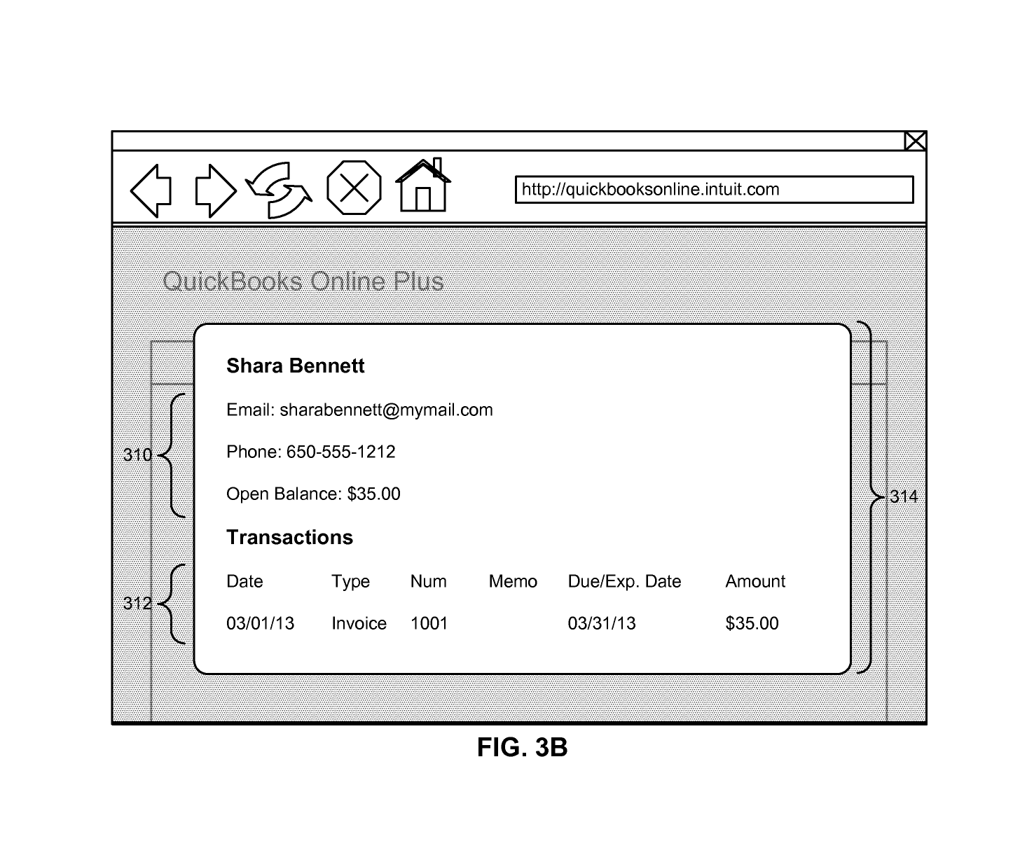

FIG. 3A shows an exemplary screenshot in accordance with the disclosed embodiments. More specifically, FIG. 3A shows a screenshot of a user interface for an application, such as user interface 120 of FIG. 1. As shown in FIG. 3A, the user interface may show a set of messages 302-306 associated with a user of the application. For example, messages 302-306 may be sent from other users of the application to the user and received in an inbox of the user provided by the application.

Within the user interface, each message may be represented by a date and a title. Message 302 may include a date of “03/01/2013” and a title of “Collect $35 from Shara Bennett.” Message 304 may include a date of “09/01/2012” and a title of “Pay employees.” Message 306 may include a date of “08/15/2012” and a title of “FY2012 Info.”

The user may select the date and/or title of each message 302-306 to view the contents of the message. For example, the user may open a message by tapping and/or clicking on the region of the user interface containing the date and/or title of the message. The user may similarly select a user-interface element 308 (e.g., “+New Message”) to navigate to a screen of the user interface for composing a message.

The user may additionally perform a gesture to access financial data associated with messages 302-306 without having to search for and/or navigate to the financial data within the user interface. For example, the user may perform a pinching gesture, a tapping gesture, a press-and-hold gesture, a panning gesture, and/or a swiping gesture over the date and/or one or more words of the title of a message to view a visualization of financial data associated with the date and/or word(s). In addition, the visualization and/or financial data shown may be based on the type of gesture performed, the region in which the gesture was performed, and/or one or more keywords associated with the region. As a result, the user interface may enable gesture-based, context-sensitive display of financial data to the user, as discussed in further detail below with respect to FIG. 3B.

FIG. 3B shows an exemplary screenshot in accordance with the disclosed embodiments. More specifically, FIG. 3B shows a screenshot of the user interface of FIG. 3A after the user performs a gesture over a region associated with message 302. For example, the user interface of FIG. 3B may be shown after the user performs a press-and-hold gesture and/or a pinching gesture over the words “Shara Bennett” in the title of message 302.

In response to the gesture, the user interface may display an overlay 314 containing a visualization of financial data corresponding to a context of the gesture. The visualization may include a list 310 of information related to a customer named Shara Bennett, such as an email address (e.g., “sharabennett@mymail.com”), phone number (e.g., “650-555-1212”), and an open balance (e.g., “$35.00”) for the customer. The visualization may also include a table 312 containing details of a transaction with the customer, including a date (e.g., “03/01/13”), a type (e.g., “Invoice”), a number (e.g., “1001”), a due date (e.g., “03/31/13”), and an amount (e.g., “$35.00”).

The user may use the financial data in list 310 and/or table 312 to perform one or more tasks related to message 302. For example, the user may use the email address in list 310 and transaction information in table 312 to send an email reminder to the customer of the invoice and/or the customer's balance. In addition, the visualization may allow the user to generate and send the email reminder more quickly and/or efficiently than if the user were required to search for the customer's contact information and/or transactions within the user interface.

After the user is finished using the visualization, the user may remove the visualization from the user interface by performing a second gesture that is complementary to the first gesture used to initiate the display of the visualization. For example, the user may use a pinch-to-zoom gesture with a “zooming in” motion to view the visualization within overlay 314 and a pinch-to-zoom gesture with a “zooming out” motion to remove overlay 314 from the user interface. Alternatively, the user may perform a panning motion in one direction to access the visualization in overlay 314 and a panning motion in the opposite direction to remove the visualization and/or overlay 314 from view.

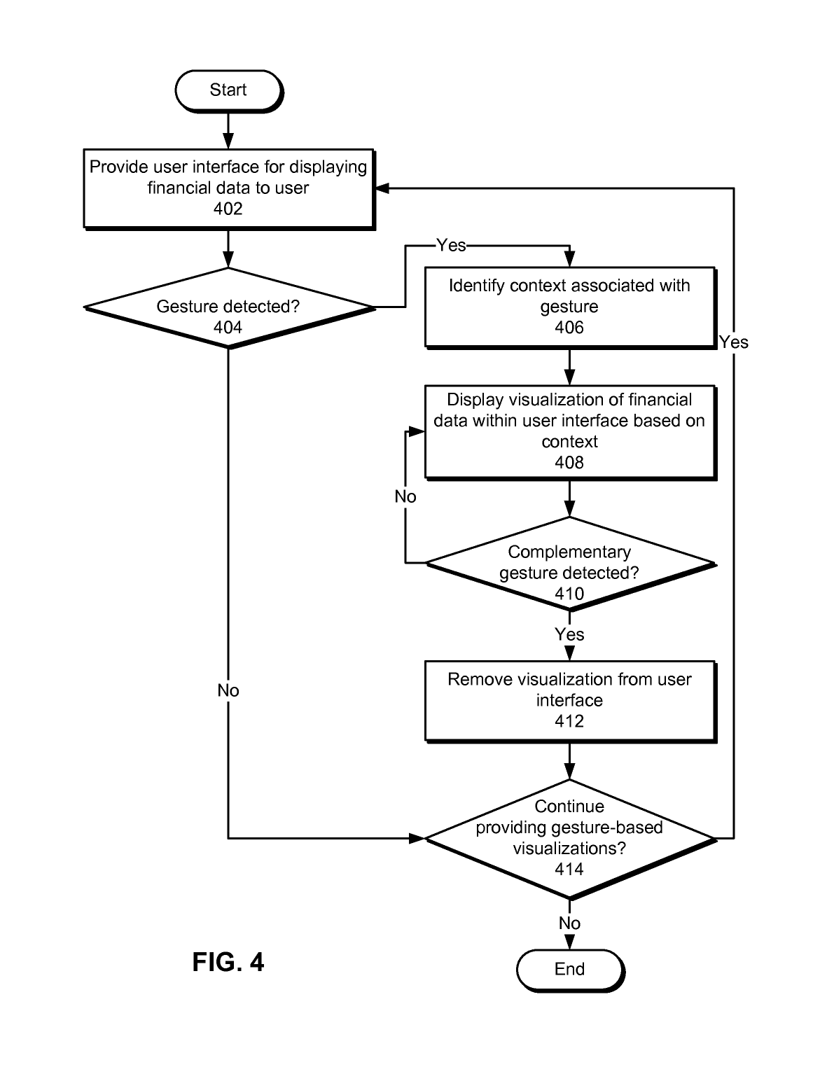

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a user interface for displaying the financial data is provided to a user (operation 402). The user interface may be a GUI, web-based user interface, touch-based user interface, and/or other type of user interface. During interaction with the user interface, the user may provide a gesture that is detected (operation 404) through the user interface and/or an interaction apparatus (e.g., application) associated with the user interface. The gesture may be a pinching gesture, a tapping gesture, a press-and-hold gesture, a panning gesture, and/or a swiping gesture. If no gesture is detected, use of the user interface may continue without showing a gesture-based visualization within the user interface.

If a gesture is detected, a context associated with the gesture is identified (operation 406). During identification of the context, a type of the gesture may be identified (e.g., pinching, tapping, press-and-hold, panning, swiping, etc.). A region of the user interface associated with the gesture may also be obtained, and one or more keywords associated with the region may be identified. The keyword(s) may then be matched to the financial data. If the financial data matches more than one keyword, a selection of a keyword may be obtained from the user, and a subset of the financial data matching the keyword may be obtained and used as the context.

Next, a visualization of the financial data is displayed within the user interface based on the context (operation 408). The visualization may include a chart, a list, a map, a hierarchy, a network, and/or a table. In addition, the type of visualization shown may be based on the context and/or financial data matching the context.

A complementary gesture may be detected (operation 410) during display of the visualization. The complementary gesture may include a motion that is opposite the motion of the gesture. If the complementary gesture is not detected, the visualization may continue to be displayed (operation 408). If the complementary gesture is detected, the visualization is removed from the user interface (operation 412).

Gesture-based visualizations may continue to be provided (operation 414) during use of the interface by the user. If the gesture-based visualizations are to be provided, the user interface is used to display the financial data (operation 402), and gestures detected through the user interface are used to display and/or remove context-based visualizations of the financial data (operations 404-412). Gesture-based visualizations may thus continue to be shown within the user interface until the user interface is no longer used by the user.

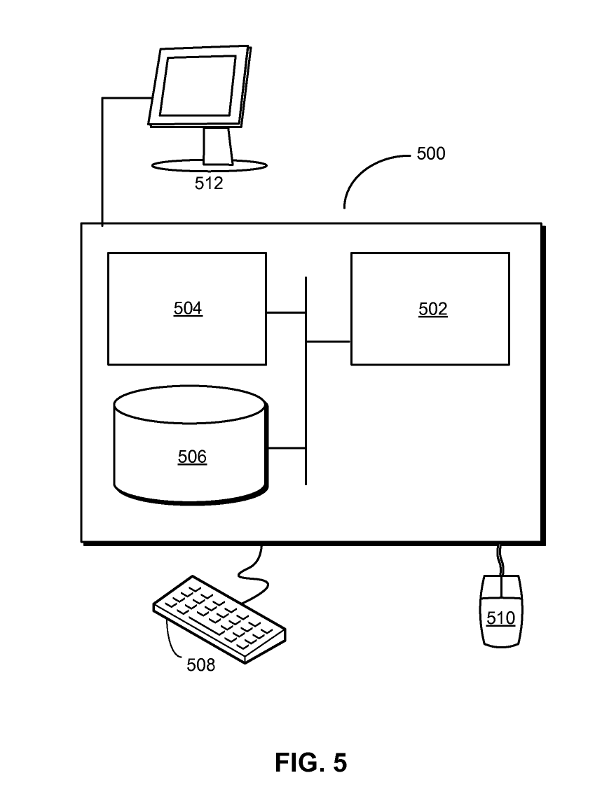

FIG. 5 shows a computer system 500 in accordance with an embodiment. Computer system 500 may correspond to an apparatus that includes a processor 502, memory 504, storage 506, and/or other components found in electronic computing devices such as personal computers, laptop computers, workstations, servers, mobile phones, tablet computers, and/or portable media players. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system may include an interaction apparatus that detects a gesture provided by a user through a user interface. The system may also include an analysis apparatus that identifies a context associated with the gesture. Finally, the system may include the user interface, which displays a visualization of the financial data based on a context associated with the gesture.

In addition, one or more components of computer system 500 may be remotely located and connected to the other components over a network. Portions of the present embodiments (e.g., interaction apparatus, analysis apparatus, user interface, etc.) may also be located on different nodes of a distributed system that implements the embodiments. For example, the present embodiments may be implemented using a cloud computing system that provides gesture-based visualizations of data to a set of remote users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for processing financial data, comprising:
providing a user interface for displaying the financial data to a user; and
upon detecting a gesture provided by the user through the user interface:
identifying a context associated with the gesture; and
displaying a visualization of the financial data within the user interface based on the context.

2. The computer-implemented method of claim 1, further comprising:
upon detecting a complementary gesture provided by the user through the user interface, removing the visualization from the user interface.

3. The computer-implemented method of claim 2,
wherein the gesture comprises a first motion, and
wherein the complementary gesture comprises a second motion that is opposite the first motion.

4. The computer-implemented method of claim 1, wherein identifying the context associated with the gesture involves at least one of:
identifying a type of the gesture;
obtaining a region of the user interface associated with the gesture;
identifying one or more keywords associated with the region; and
matching the one or more keywords to the financial data.

5. The computer-implemented method of claim 4, wherein matching the one or more keywords to the financial data involves:
if the financial data matches more than one keyword:
obtaining, from the user, a selection of a keyword from the one or more keywords; and
obtaining a subset of the financial data matching the keyword.

6. The computer-implemented method of claim 1, wherein the visualization comprises at least one of:
a chart;
a list;
a map;
a hierarchy;
a network; and
a table.

7. The computer-implemented method of claim 1, wherein the gesture is at least one of:
a pinching gesture;
a tapping gesture;
a press-and-hold gesture;
a panning gesture; and
a swiping gesture.

8. The computer-implemented method of claim 1, wherein the visualization is displayed within an overlay in the user interface.

9. A system for processing financial data, comprising:
an interaction apparatus configured to detect a gesture provided by a user through a user interface;
an analysis apparatus configured to identify a context associated with the gesture; and
the user interface configured to display a visualization of the financial data based on a context associated with the gesture.

10. The system of claim 9,
wherein the interaction apparatus is further configured to detect a complementary gesture provided by the user through the user interface, and
wherein the user interface is further configured to remove the displayed visualization in response to the complementary gesture.

11. The system of claim 9, wherein identifying the context associated with the gesture involves at least one of:
identifying a type of the gesture;
obtaining a region of the user interface associated with the gesture;
identifying one or more keywords associated with the region; and
matching the one or more keywords to the financial data.

12. The system of claim 11, wherein matching the one or more keywords to the financial data involves:
if the financial data matches more than one keyword:
obtaining, from the user, a selection of a keyword from the one or more keywords; and
obtaining a subset of the financial data matching the keyword.

13. The system of claim 9, wherein the visualization comprises at least one of:
a chart;
a list;
a map;
a hierarchy;
a network; and
a table.

14. The system of claim 9, wherein the gesture is at least one of:
a pinching gesture;
a tapping gesture;
a press-and-hold gesture;
a panning gesture; and
a swiping gesture.

15. A computer-readable storage medium storing instructions that when executed by a computer cause the computer to perform a method for processing financial data, the method comprising:
providing a user interface for displaying the financial data to a user; and
upon detecting a gesture provided by the user through the user interface:
identifying a context associated with the gesture; and
displaying a visualization of the financial data within the user interface based on the context.

16. The computer-readable storage medium of claim 15, the method further comprising:
upon detecting a complementary gesture provided by the user through the user interface, removing the visualization from the user interface.

17. The computer-readable storage medium of claim 16,
wherein the gesture comprises a first motion, and
wherein the complementary gesture comprises a second motion that is opposite the first motion.

18. The computer-readable storage medium of claim 15, wherein identifying the context associated with the gesture involves at least one of:
identifying a type of the gesture;
obtaining a region of the user interface associated with the gesture;
identifying one or more keywords associated with the region; and
matching the one or more keywords to the financial data.

19. The computer-readable storage medium of claim 18, wherein matching the one or more keywords to the financial data involves:
if the financial data matches more than one keyword:
obtaining, from the user, a selection of a keyword from the one or more keywords; and
obtaining a subset of the financial data matching the keyword.

20. The computer-readable storage medium of claim 15, wherein the visualization comprises at least one of:
a chart;
a list;
a map;
a hierarchy;
a network; and
a table.

21. The computer-readable storage medium of claim 15, wherein the visualization is displayed within an overlay in the user interface.
